(19) United States
(12) Patent Application Publication
(10) Pub. No.: US 2010/0247062 A1
(43) Pub. Date: Sep. 30, 2010

(54) INTERACTIVE MEDIA PLAYER SYSTEM

(76) Inventor: Scott J. Bailey, Seattle, WA (US)

Correspondence Address: DICKSTEIN SHAPIRO LLP, 1633 Broadway, NEW YORK, NY, 10019, US

(21) Appl. No.: 12/732,965

(22) Filed: Mar. 26, 2010

Related U.S. Application Data
(60) Provisional application No. 61/211,084, filed on Mar. 27, 2009.

(51) Int. Cl. H04N 5/93

(52) U.S. Cl. 386/52; 348/E05.028

(57) ABSTRACT

An interactive media player system and method is disclosed that permits a user to interact with audiovisual media (“videos”) during playback, by allowing the user to integrate audio or visual filters at certain temporal points and screen positions in the playback of the videos. The system is preferably designed to control playback via touch-screen devices like mobile phones, mobile media players, computers and free-standing video gaming devices, or desktop systems using a mouse. The system records the user interaction to generate a history track that can be shared or applied to other videos. In an alternative embodiment, the system is designed to control playback through the use of other user-input devices, such as a mouse on a traditional desktop platform.

### CROSS-REFERENCE TO RELATED APPLICATIONS

The present utility application claims the benefit of U.S. Provisional Patent Application Ser. No. 61/211,084, filed Mar. 27, 2009, the entirety of which is incorporated by reference herein.

### FIELD OF THE INVENTION

The present invention relates generally to user interfaces for computer systems and hand-held devices, and particularly to a system and method for a device that allows a user to interact with audiovisual media during media playback.

### BACKGROUND OF THE INVENTION

Audiovisual media (hereinafter “videos”) have become an essential part of our viewing entertainment. Hand-held devices, such as small-screen PDAs and cell phones, are gaining popularity in browsing videos. Indeed, recent advances in miniaturization and processing capacity have rendered hand-held devices with the computational power of latter-day desktop computing systems. Browsing videos with these hand-held devices is a passive task, easily invoked by the touch on the screen or a click of a button. The entertainment value is limited to viewing the video. The user has no creative input toward the experience.

Thus, there is a need for developing techniques to improve the user experience on both computer and mobile hand-held users to permit user interaction during the playback of videos.

### SUMMARY OF THE INVENTION

The present invention is directed to an interactive media player system and method that permits a user to interact with audiovisual media (“videos”) during playback, by allowing the user to integrate audio or visual filters at certain temporal points and screen positions in the playback of the videos. The system is preferably designed to control playback via touch-screen devices like mobile phones, mobile media players, computers and free-standing video gaming devices, or desktop systems using a mouse. The system records the user interaction to generate a history track that can be shared or applied to other videos. In an alternative embodiment, the system is designed to control playback through the use of other user-input devices, such as a mouse on a traditional desktop platform.

In one aspect, the present invention is directed to a method of adding audiovisual effects to a video having a beginning and an end, comprising: starting playback of the video on a display; accepting selection of a filter that provides an audiovisual effect to the video; receiving selection of a display position; recording a time duration relative to the beginning of the video, the filter selected and the display position selected to create an interaction history track; displaying the audiovisual effect provided by the filter using the selected display position as playback of the video proceeds; and repeating the accepting, receiving, recording and displaying steps until reaching the end of the video.

In another aspect of the present invention, the filter comprises a kaleidoscopic effect centered at the selected display position by mirroring and repeating specific areas of the picture into the remainder of the display around the selected display position.

In another aspect of the present invention, the filter comprises a swirl effect centered at the selected display position by altering the values or frequencies of pixel locations around the selected display position.

In another aspect of the present invention, the filter comprises an abstraction effect by altering pixel location, color, saturation, brightness or contrast around the selected display position.

In another aspect of the present invention, the displaying step applies the effect of the selected filter on an unfiltered copy of the video.

In another aspect of the present invention, the displaying step applies the effect of the selected filter in a cumulative fashion on a filtered copy of the video.

In another aspect of the present invention, receiving selection of the display position is made by a touch screen.

In another aspect of the present invention, receiving selection of the display position is made by receiving a signal from a mouse.

In another aspect of the present invention, combining a previously recorded interaction history track with playback of the video and the created interaction history track; and displaying the audiovisual effects provided by the previously recorded interaction history track and the created interaction history track.

In yet another aspect, the present invention is directed to a system for adding audiovisual effects to a video having a beginning and an end, the system comprising: a processor; a display; a memory; a position selection device; and code that, when loaded and run by the processor, causes the processor to perform steps, comprising: starting playback of the video on the display; accepting selection of a filter that provides an audiovisual effect to the video; receiving selection of a display position; recording a time duration relative to the beginning of the video, the filter selected and the display position selected; displaying the audiovisual effect provided by the filter using the selected screen position as playback of the video proceeds; and repeating the accepting, receiving, recording and displaying steps until reaching the end of the video.

In another aspect of the present invention, the filter comprises a kaleidoscopic effect centered at the selected display position by mirroring and repeating specific areas of the picture into the remainder of the display around the selected display position.

In another aspect of the present invention, the filter comprises a swirl effect centered at the selected display position by altering the values or frequencies of pixel locations around the selected display position.

In another aspect of the present invention, the filter comprises an abstraction effect by altering pixel location, color, saturation, brightness or contrast around the selected display position.

In another aspect of the present invention, the displaying step applies the effect of the selected filter on an unfiltered copy of the video.

In another aspect of the present invention, the displaying step applies the effect of the selected filter in a cumulative fashion on a filtered copy of the video.

In another aspect of the present invention, the display and the position selection device are a touch screen.

In another aspect of the present invention, the position selection device is a mouse.

In another aspect of the present invention, the steps further comprise combining a previously recorded interaction history track with playback of the video and the created interaction history track; and displaying the audiovisual effects provided by the previously recorded interaction history track and the created interaction history track

These and further features and advantages of the present invention will become more apparent from the following description when taken in connection with the accompanying drawings which show, for purposes of illustration only, several embodiments in accordance with the present invention.

### BRIEF DESCRIPTION OF THE DRAWINGS

FIG. 1 is an architectural block diagram for a system embodiment of the present invention;

FIGS. 2A-H are screen shots of exemplary display effects when filters are applied using the present invention;

FIG. 3 is a conceptual diagram illustrating an interaction history track using the present invention;

FIG. 4 is a flow chart outlining steps performed for editing videos on a graphical user interface in accordance with an embodiment of the present invention; and

FIG. 5 illustrates examples of computer readable media.

### DETAILED DESCRIPTION OF PREFERRED EMBODIMENTS OF THE INVENTION

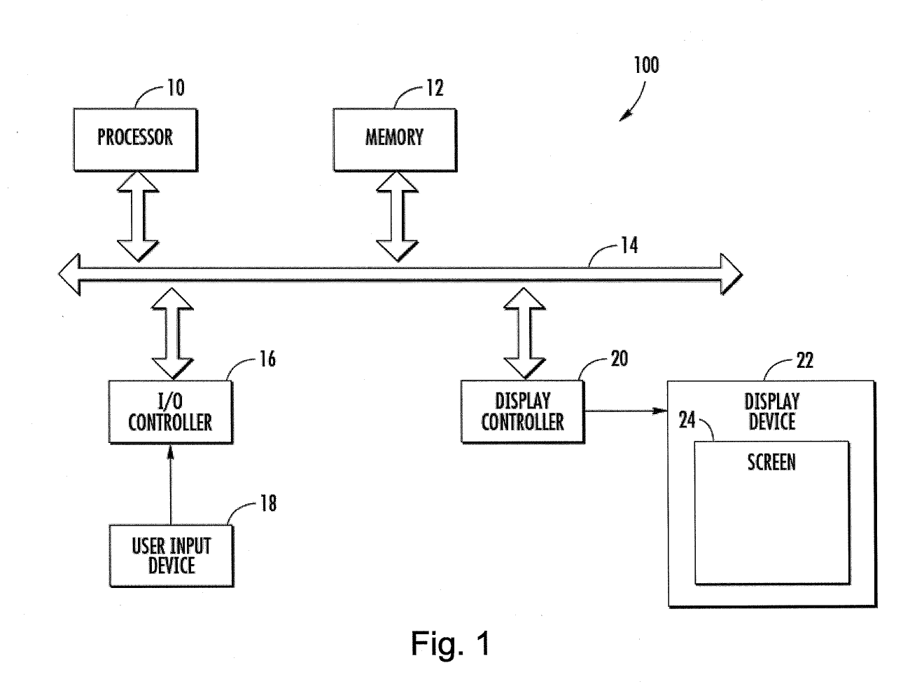

FIGS. 1-5, discussed below, and the embodiment used to describe the principles of the present invention are by way of illustration only and should not be construed in any way to limit the scope of the invention. Well-known components have been shown in block diagram form in order not to obscure the present invention in unnecessary detail. Certain details regarding graphical user interfaces described herein have been omitted insomuch as such details are not necessary to obtain a complete understanding of the present invention and are within the skill of a person of ordinary skill in the relevant art.

The interactive media player system is designed to permit a user to interact with audiovisual media (“videos”) during playback, by allowing the user to integrate audio or visual effects (“filters”) at certain temporal points and screen positions in the playback of the videos. The system is preferably designed to control playback via touch-screen devices like mobile phones, mobile media players, computers and free-standing video gaming devices. In an alternative embodiment, the system is designed to control playback through the use of other user-input devices, such as a mouse on a traditional desktop platform.

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as Basic, C, C++, C#, Java, HTML, COBOL, assembler, PERL, or the like, with the various algorithms being implemented with any combination of data structures, objects, processes, routines or other programming elements. The computer code is preferably programmed in C++. The object code can preferably be executed by any computer having a Windows 98 or higher or MAC O.S. 9 or higher operating system, or on one of the many hand-held device operating systems such as Symbian, WebOS, Windows Phone 7, Android or iPhone.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

System Architecture

The present invention is for use with display screens and monitors, such as those used in conjunction with computing devices, PDAs, cell phones, and other handheld mobile devices. Referring to FIG. 1, system 100 includes a processor 10, memory 12, system bus 14, I/O controller 16, user input device 18, display controller 20 and display device 22. Processor 10 and memory 12 are interconnected by system bus 14 which includes control signals as well as address lines and data lines for sharing information, including data and instructions, between the components of system 100. Also connected to system bus 14 is I/O controller 16 which controls signals received from user input device 18 and provides those signals, which indicate instructions from the user, to processor 10. User input device 18 can include a keyboard, mouse, touchpad, trackball, pen input mechanism, or any other device capable of receiving user input. Any device capable of indicating and selecting x-y coordinates on display device 22 may be utilized as user input device 18. In accordance with a preferred embodiment of the present invention, user input device 18 is a touch screen which can detect the position of touches within the display area 24 of display device 22. This allows display device 22 to be used as an input device, removing the keyboard and/or the mouse as the primary input device for interacting with the display's content.

Display controller 20 is coupled to the system bus 14 and receives commands and data from processor 10 and from memory 12 via system bus 14. Display controller 20 controls display device 22 which provides images on display screen 24. Display device 22 may be any one of a variety of known display devices found on computer monitors, PDAs, cell phones and other hand held computing devices. One example of display device 22 is a liquid crystal display.

User input device 18 provides user control allowing the user to point to a position on display screen 24 and perform an operation on that item using processor 10, such as signaling to system 100 that a particular operation should be performed, as selected by the user. Since the operation of pointing to a position using touch screens is well known in the art further discussion on the use of touch screens has been omitted.

Audio and Video filters

The interactive media player of the present invention includes user selectable filters that affect the playback of the videos. One exemplary embodiment of the system is equipped with video “filters” that affect the picture during playback. Another exemplary embodiment of the system is equipped with audio “filters” that affect the sound during playback. A preferred embodiment of the system is equipped with both video and audio “filters” that affect either or both the sound and/or picture during playback. In an aspect of the invention, a user can create effects using the available video filters for video, and then separately create effects using the available audio filters for audio. In another aspect of the invention, a user can create effects using the available video and audio filters for both video and audio at the same time.

Video Filters

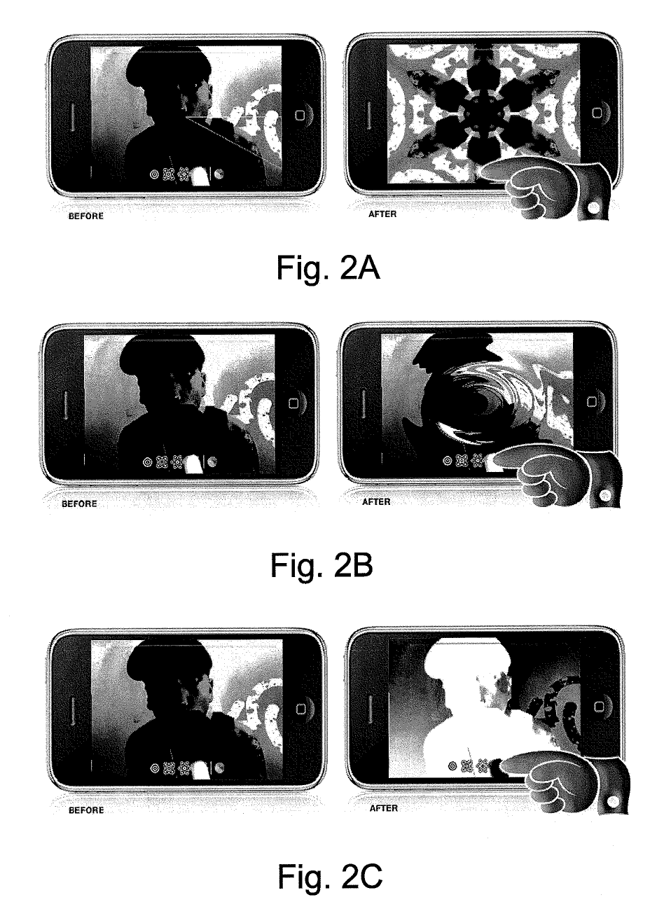

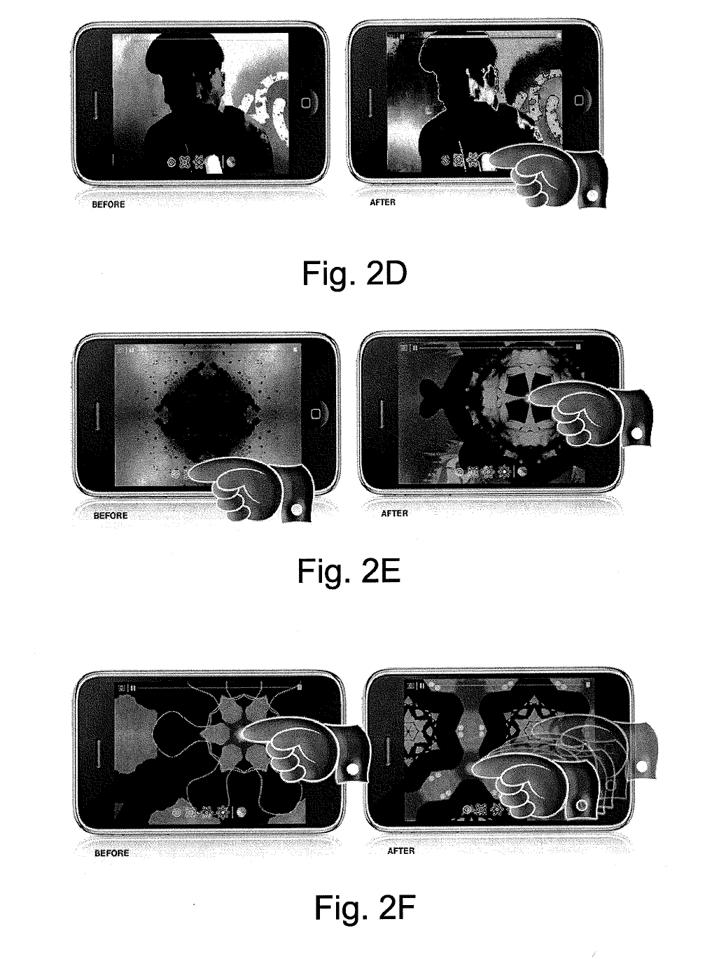

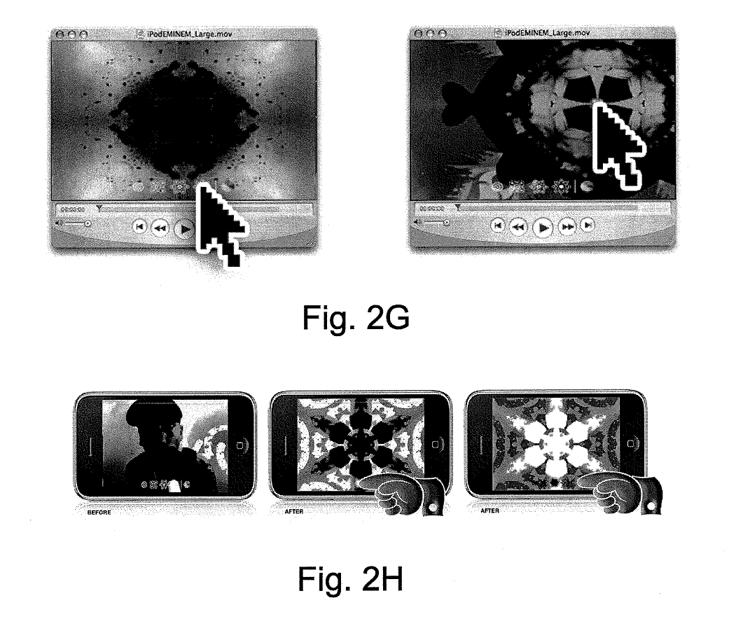

FIGS. 2A-H are screen shots of exemplary display effects when video filters are applied using the present invention. Video filter effects range in complexity and cause varying levels of distortion and/or abstraction of the original video images. Video filter effects include a multitude of pixel displacement, distortion and/or rearrangement effects, which include, but are not limited to kaleidoscopic mirroring effects, rippling, waves, fisheye, stretching, repeating in multiplicity. Video filters may also comprise pixel alteration without displacement, which include, but are not limited to shifts in color, saturation, brightness, contrast and inversion effects.

FIG. 2A illustrates the before and after application of a kaleidoscopic video filter selected by the user and applied to a screen position near the center of the video. This filter causes kaleidoscopic effects by mirroring and repeating specific areas of the picture into the remainder of the frame.

Other video filters cause distortions and/or abstractions by altering the values and/or frequencies of pixel location, color, saturation, brightness and contrast. For example, FIG. 2B illustrates the before and after application of a filter that creates a swirling or rippling effect by distorting the image on the screen, as if the surface of the screen were liquid and a pebble were cast into the screen at the selected position. FIG. 2C illustrates the application of a contrast filter, where pixels in a group bounded by an edge surrounding the selected position have brightness or contrast qualities changed. FIG. 2D illustrates the application of yet another pixel oriented alteration where visual qualities of pixels in a group bounded by an edge encompassing the selected position are changed.

In touch-screen featured applications on touch screen mobile devices, e.g., touch screen mobile phones or smartphones (e.g., the iPhone®) or other computing devices with a touch screen interface (e.g., iPad™, computers with touch screen monitors), filter effects are applied with touch-point buttons that are overlaid on the media itself and/or on the media player, and further controlled by touching the screen itself, which, by defining X and Y axis position(s) of the planar touch-screen, indicates where and/or how a specific or previous filter effect should be further defined. FIG. 2E illustrates selection of a particular filter effect from an overlaid menu and application of that effect by selection of a position on the screen. FIG. 2F illustrates selection of several more positions on the screen during the playback of the media that applies yet another instance of the filter to the video playback.

In one aspect of the invention, the touch-point menu buttons can be programmed to define how the media is filtered, i.e., selection of the filter effect, while the positions selected on the screen are programmed to defined an origin to apply the filter effects.

In an alternative embodiment designed to run on non-touch screen mobile devices or other computing devices without a touch-screen interface, filtration effects are applied with mouse-click buttons on the screen and further controlled by mouse-clicking areas of the screen itself, which, by defining X and Y axis position(s) of the screen, indicates where and/or how a specific effect should be applied. FIG. 2G illustrates a cursor selection of positions on the screen in such a device.

In a preferred embodiment, a plurality of filter effects can be applied at a selected screen position. For example, a first filter effect can be applied, and thereafter another, different filter effect can be applied on top of the first filter effect. FIG. 2H illustrates the application of multiple effects originating at a selected screen position.

Audio Filters

Audio filter effects create distortions similar to that of video filters, only they apply to sound qualities rather than picture qualities. Like a DJ's audio mixing technologies and/or equipment, where changes are applied via rheostat, potentiometer, or other hand-controlled electronic technologies, in an aspect of the present invention, a user can apply audio filter effects to media via touch-screen interaction or via “mouse” in real-time on a non-touch-screen application with an interactive graphical user interface.

Audio filters can cause varying levels of distortion of original audio sounds. They include but are not limited to changes in any of or a combination of the six (6) known qualities of sound, loudness, pitch, tone (timbre or ‘color’), direction (balance), phase and reverberation.

Audiovisual Playback

Although filter effects are applied during the course of playback, another aspect of the invention is the creation of a new and separate timeline or track, which “mirrors” the original time-code of an audio or video file without altering it in anyway.

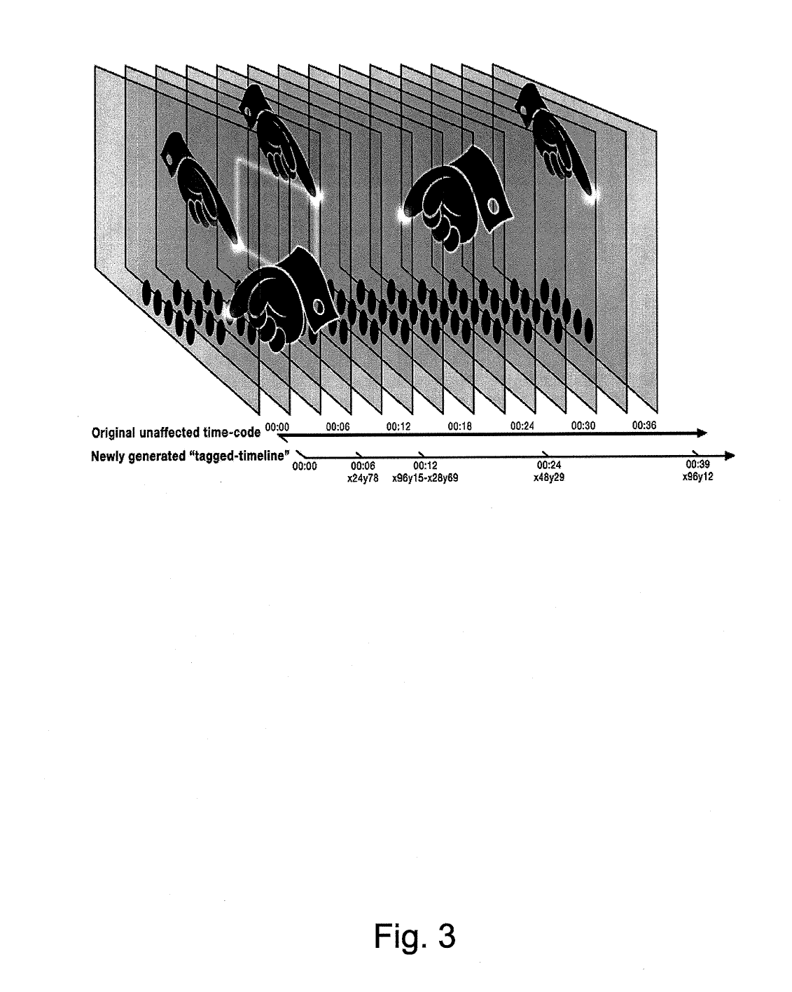

All interactions with the screen are captured and recorded on this new track, generating an “interaction history” of any given touch-point interaction during playback. FIG. 3 illustrates the concept of recording an interaction history track. The original video can be played again with a new interaction history track overlaid on the video, which affects the playback in perpetuity. The new interaction history track preferably comprises only a few kilobytes of information, which can easily be separated from the video and shared among users by whatever transmission means are convenient, such as email, instant message, file transfer and the like. The new interaction history track determines the filter effects applied to the original video during real-time playback, provided the recipient also has the original video. Further, the recipient can use the system to apply further filter effects, and record those effects which supplement the effects provided in the original interaction history track.

Method of Editing Videos

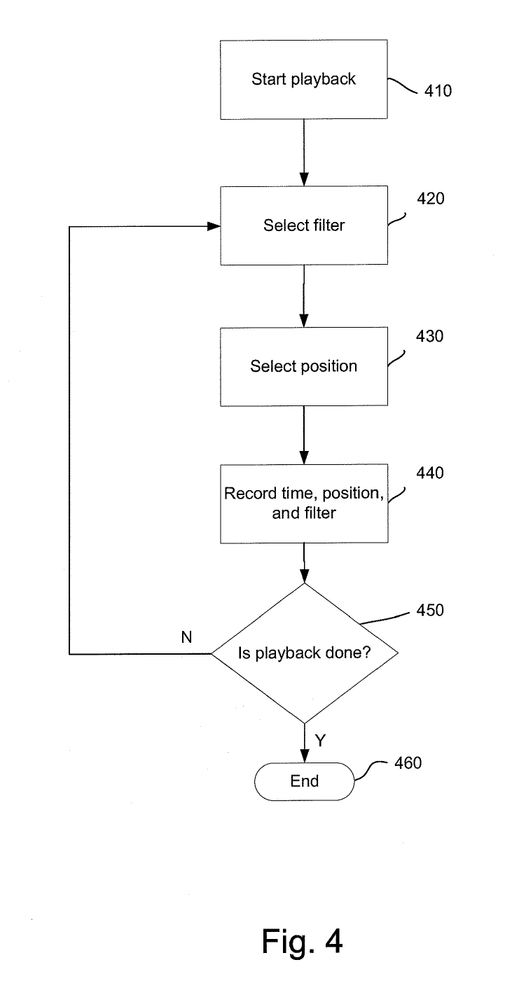

FIG. 4 is a flow chart outlining steps performed for editing videos on a graphical user interface in accordance with an embodiment of the present invention. As shown in FIG. 4, in step 410 a user selects a video for playback and starts playing it on the system. In step 420, the user selects a filter from the on-screen menu of available filters. Next, in step 430, the user selects a position on the screen that acts as an origin for the application of the filter effect. In step 440, the system records to a media the elapsed time relative to the beginning of the video that the video has been playing, the origin position selected by the user and the filter selected by the user. In step 450, the system checks whether playback of the video has completed. If not, the method repeats at step 420, awaiting selection of a filter. Alternatively, processing can skip to step 430 if the user is applying the same filter at a different position in the video. If video playback has completed, then in step 460 the method has ended.

Software on Media

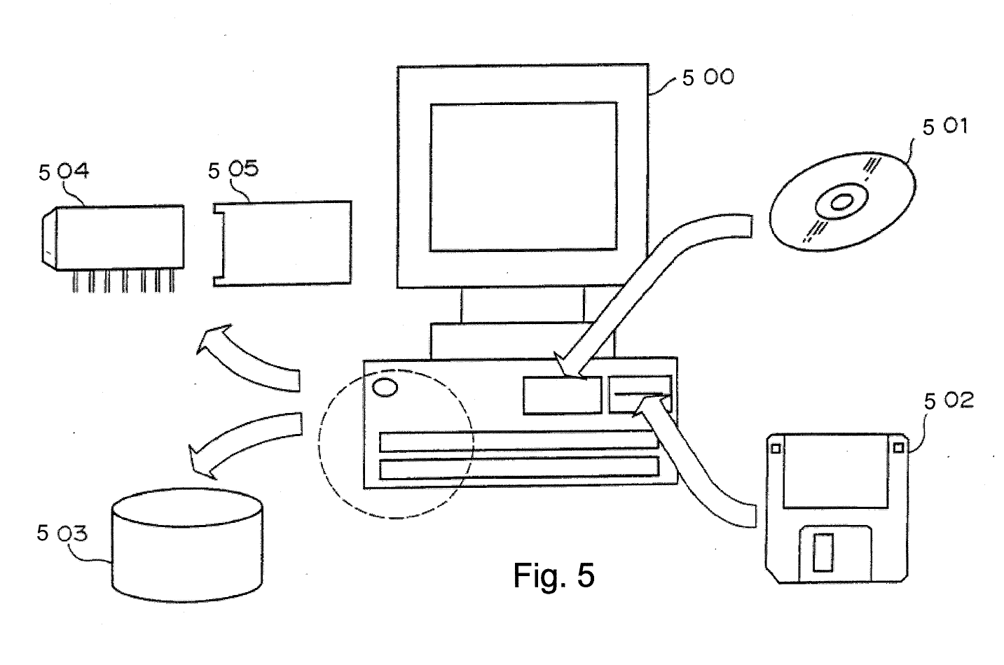

In the specification, the term “media” means any medium that can record data therein. FIG. 5 illustrates examples of recording media.

The term “media” includes, for instance, a disk shaped media 501 such as CD-ROM (compact disc-read only memory), magneto optical disc or MO, digital video disc-read only memory or DVD-ROM, digital video disc-random access memory or DVD-RAM, a floppy disc 502, a memory chip 504 such as random access memory or RAM, read only memory or ROM, erasable programmable read only memory or E-PROM, electrical erasable programmable read only memory or EE-PROM, a rewriteable card-type read only memory 505 such as a smart card, a magnetic tape, a hard disc 503, and any other suitable means for storing a program therein.

A recording media storing a program for accomplishing the above mentioned apparatus may be accomplished by programming functions of the above mentioned apparatuses with a programming language readable by a computer 500 or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer processing device 500, any suitable device for performing computations in accordance with a computer program may be used. Examples of such devices include a personal computer, a laptop computer, a microprocessor, a programmable logic device, or an application specific integrated circuit.

One skilled in the art will appreciate that additional variations may be made in the above-described embodiment of the present invention without departing from the spirit and scope of the invention which is defined by the claims which follow.

What is claimed is:

1. A method of adding audiovisual effects to a video having a beginning and an end, comprising:
starting playback of the video on a display;
accepting selection of a filter that provides an audiovisual effect to the video;
receiving selection of a display position;
recording a time duration relative to the beginning of the video, the filter selected and the display position selected to create an interaction history track;
displaying the audiovisual effect provided by the filter using the selected display position as playback of the video proceeds; and
repeating the accepting, receiving, recording and displaying steps until reaching the end of the video.

2. The method of claim 1, wherein the filter comprises a kaleidoscopic effect centered at the selected display position by mirroring and repeating specific areas of the picture into the remainder of the display around the selected display position.

3. The method of claim 1, wherein the filter comprises a swirl effect centered at the selected display position by altering the values or frequencies of pixel locations around the selected display position.

4. The method of claim 1, wherein the filter comprises an abstraction effect by altering pixel location, color, saturation, brightness or contrast around the selected display position.

5. The method of claim 1, wherein the displaying step applies the effect of the selected filter on an unfiltered copy of the video.

6. The method of claim 1, wherein the displaying step applies the effect of the selected filter in a cumulative fashion on a filtered copy of the video.

7. The method of claim 1, wherein receiving selection of the display position is made by a touch screen.

8. The method of claim 1, wherein receiving selection of the display position is made by receiving a signal from a mouse.

9. The method of claim 1, further comprising combining a previously recorded interaction history track with playback of the video and the created interaction history track; and displaying the audiovisual effects provided by the previously recorded interaction history track and the created interaction history track.

10. A system for adding audiovisual effects to a video having a beginning and an end, the system comprising:
a processor;
a display;
a memory;
a position selection device; and
code that, when loaded and run by the processor, causes the processor to perform steps, comprising:
starting playback of the video on the display;
accepting selection of a filter that provides an audiovisual effect to the video;
receiving selection of a display position;
recording a time duration relative to the beginning of the video, the filter selected and the display position selected;
displaying the audiovisual effect provided by the filter using the selected screen position as playback of the video proceeds; and
repeating the accepting, receiving, recording and displaying steps until reaching the end of the video.

11. The system of claim 10, wherein the filter comprises a kaleidoscopic effect centered at the selected display position by mirroring and repeating specific areas of the picture into the remainder of the display around the selected display position.

12. The system of claim 10, wherein the filter comprises a swirl effect centered at the selected display position by altering the values or frequencies of pixel locations around the selected display position.

13. The system of claim 10, wherein the filter comprises an abstraction effect by altering pixel location, color, saturation, brightness or contrast around the selected display position.

14. The system of claim 10, wherein the displaying step applies the effect of the selected filter on an unfiltered copy of the video.

15. The system of claim 10, wherein the displaying step applies the effect of the selected filter in a cumulative fashion on a filtered copy of the video.

16. The system of claim 10, wherein the display and the position selection device are a touch screen.

17. The system of claim 10, wherein the position selection device is a mouse.

18. The system of claim 10, wherein the steps further comprise combining a previously recorded interaction history track with playback of the video and the created interaction history track; and displaying the audiovisual effects provided by the previously recorded interaction history track and the created interaction history track.
